(19) United States
(12) Patent Application Publication
(10) Pub. No.: US 2014/0344237 A1
(43) Pub. Date: Nov. 20, 2014

(54) INFORMATION SEARCHING SYSTEM AND METHOD

(71) Applicant: HON HAI PRECISION INDUSTRY CO., LTD., New Taipei (TW)

(72) Inventor: HO-LEUNG CHEUNG, Santa Clara, CA (US)

(73) Assignee: HON HAI PRECISION INDUSTRY CO., LTD., New Taipei (TW)

(21) Appl. No.: 14/205,381

(22) Filed: Mar. 12, 2014

(30) Foreign Application Priority Data
May 17, 2013 (TW) 102117657

(51) Int. Cl. G06F 17/30

(52) U.S. Cl. CPC G06F 17/30864
USPC 707/706

(57) ABSTRACT

An information searching method is provided. The method includes the following steps: receiving accounting information and keywords by an input unit; storing a plurality of folders by a storage unit, wherein each folder stores one or more network addresses, each network address corresponds to a webpage; generating a searching instruction in response to the keywords input in the input unit, searching for webpages related to the keywords by the server in response to the searching instruction; and displaying the network addresses associated with the webpages which are searched by the server. An information searching system is also provided.

### BACKGROUND

1. Technical Field

The present disclosure relates to searching systems, and particularly to an information searching system and a method.

2. Description of Related Art

For information searching, users can generally input keywords into a search engine to search for a number of webpages which are related to the keywords. However, the searched webpages may not satisfy the actually requirement of the users when the keywords are not very accurate.

Therefore, what is needed is information searching system and a method to overcome the above described limitations.

### BRIEF DESCRIPTION OF THE DRAWING

FIG. 1 is a schematic diagram of an information searching system.

FIG. 2 is a block diagram of the information searching system of FIG. 1, in accordance with an exemplary embodiment.

FIG. 3 is flowchart of a method of keywords implemented by the information searching system of FIG. 1, in accordance with an exemplary embodiment.

### DETAILED DESCRIPTION

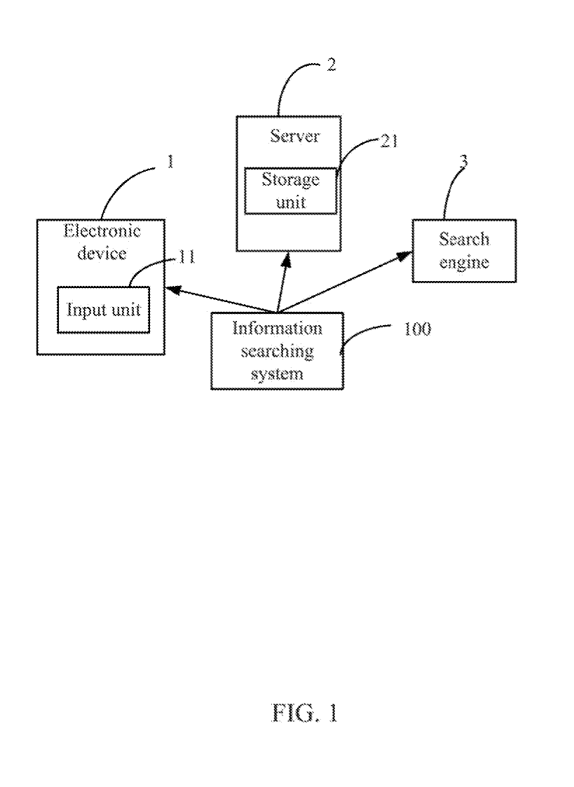

FIG. 1 shows an information searching system 100 being applied in a hardware environment, which includes an electronic device 1 and a server 2. The electronic device 1 includes an input unit 11. The input unit 11 receives account information and keywords input by a user. The account information has an authority to access the server 2. The server 2 includes a storage unit 21. The storage unit 21 stores a number of folders. Each folder stores one or more related network addresses. Each network address corresponds to a webpage. In one embodiment, the webpages corresponding to the related network addresses have same keywords.

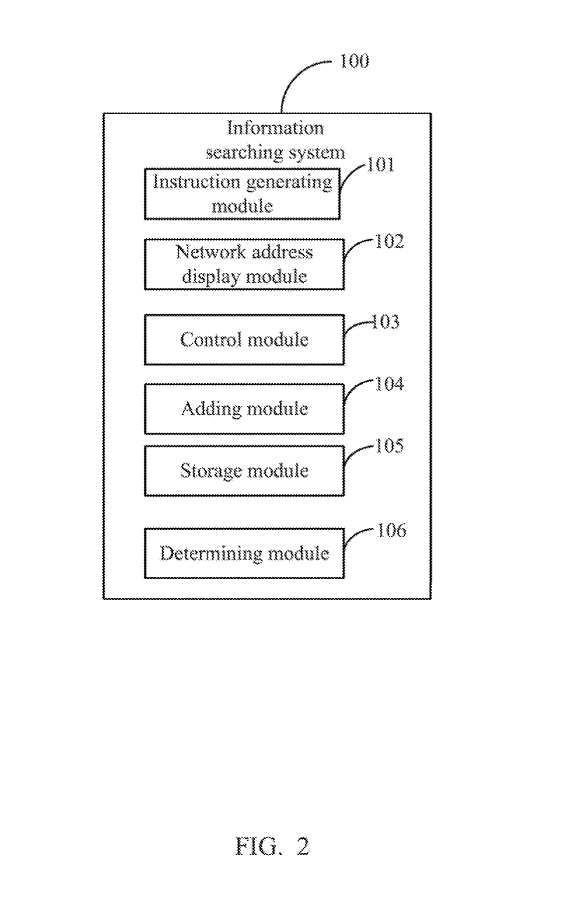

FIG. 2 shows that the information searching system 100 includes a number of modules, which are collection of software instructions and executed by one or more processors. The number of modules includes an instruction generating module 101 and a network address display module 102.

In a first embodiment, the instruction generating module 101 generates a searching instruction, and provides the searching instruction to the server 2 in response to the keywords input in a search engine 3. The searching instruction is used to control the servers 2 to search for a number of webpages related to the keywords. The network address display module 102 displays the network addresses associated with the webpages which are searched by the server 2. When there is no webpage being searched by the server 2, the instruction generating module 101 provides the searching instruction to the search engine 3. The searching instruction is used to control the search engine 3 to search for a number of webpages related to the keywords. The network address display module 102 displays the network addresses associated with the webpages which are searched by the search engine 3. In one embodiment, the search engine 3 may be BAIDU, or GOOGLE, for example.

In a second embodiment, the instruction generating module 101 generates a searching instruction, and provides the searching instruction to the server 2 and the search engine 3 in response to the keywords input in a search engine 3. The searching instruction is used to control the server 2 and the search engine 3 to search for a number of webpages related to the keywords. The network address display module 102 generates a display interface when there is a plurality of the webpages being searched by the server 2 and the search engine 3. The display interface includes a first portion and a second portion. The network address display module 102 displays the network addresses associated with the webpages being searched by the server 2 on the first portion, and displays the network addresses associated with the webpages being searched by the search engine 3 on the second portion. In one embodiment, the position of the first portion is set above the position of the second portion. In other embodiments, the position of the first portion can also be set on the right/left of the position of the second portion. In one embodiment, the instruction generating module 101 and the network address display module 102 operate on the electronic device 1.

The number of modules further includes a control module 103, an adding module 104, and a storage module 105. The control module 103 generates an add instruction to the server 2 when there is no webpage related to the keywords being searched by the server 2 but there is the number of webpages related to the keywords being searched by the search engine 3. The adding module 104 adds a new folder to the storage unit on the server 2 in response to the add instruction. The storage module 105 stores the number of network addresses associated with the webpages being searched by the search engine 3 to the new folder. In one embodiment, the control module 103 runs in the electronic device 1, the adding module 104 and the storage module 105 runs in the server 2.

The number of modules further includes a determining module 106. The determining module 106 determines whether or not there is a plurality of new network addresses associated with the webpages being searched by the search engine 3 which is not stored in the folder in the storage unit on the server 2 when there is the number of webpages related to the keywords being searched by the server 2 and there is the number of webpages related to the keywords being searched by the search engine 3. The storage module 105 stores the new network addresses associated with the webpages being searched by the search engine 3 in the folder when the new network addresses associated with the webpage being searched by the search engine 3 is not stored in the storage unit 21. The folder has already stored the number of the network addresses associated with the webpages being searched by the server 2. In one embodiment, the determining module 106 operates on the electronic device 1.

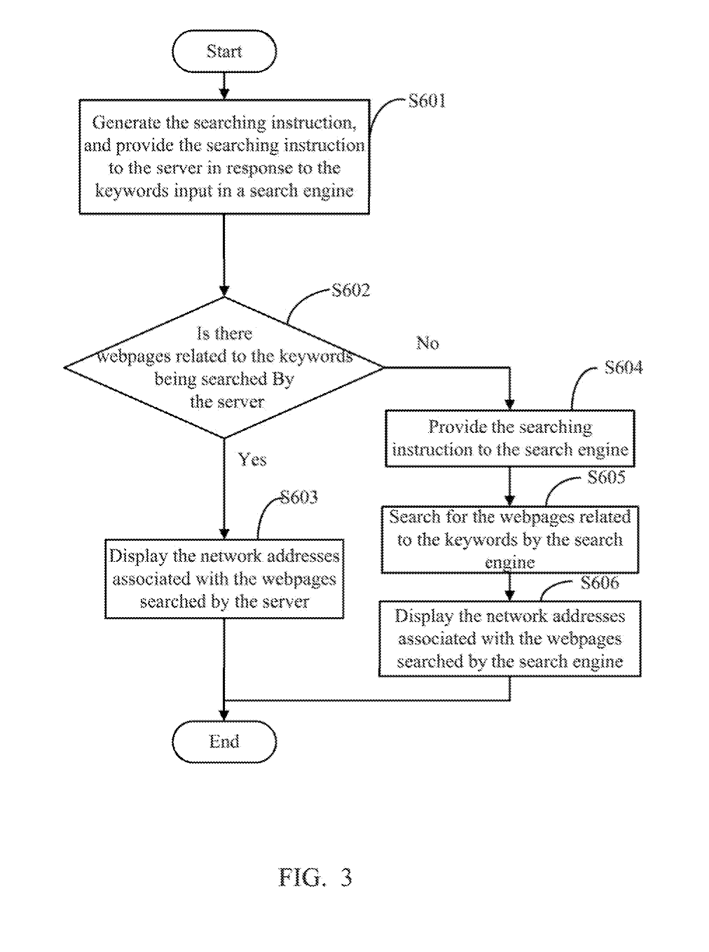

FIG. 3 is flowchart of a method of searching information implemented by the information searching system of FIG. 1, in accordance with an exemplary embodiment.

In step S601, the instruction generating module 101 generates the searching instruction, and provides the searching instruction to the server 2 in response to the keywords input in a search engine 3.

In step S602, the servers 2 determines whether or not there is a number of webpages related to the keywords in response to the search instruction, if yes, the procedure goes to step S603, if no, the procedure goes to S604.

In step S603, the network address display module 102 displays the network addresses associated with the webpages being searched by the server 2.

In step S604, the instruction generating module 101 provides the searching instruction to the search engine 3.

In step S605, the search engine 3 searches for a number of webpages related to the keywords in response to the searching instruction.

In step S606, the network address display module 102 displays the network addresses associated with the webpages being searched by the search engine 3.

In a second embodiment, the method further includes the following steps: the instruction generating module 101 generates the searching instruction, and provides the searching instruction to the server 2 and the search engine 3 in response to the keywords input in a search engine 3. The server 2 and the search engine 3 search for a number of webpages which are related to the keywords in response to the searching instruction. The network address display module 102 generates a display interface when there is the webpage being searched by the server 2 and the search engine 3. The display interface includes a first portion and a second portion. The network address display module 102 displays the network addresses associated with the webpages being searched by the server 2 on the first portion, and displays the network addresses associated with the webpages being searched by the search engine 3 on the second portion.

The method further includes the following steps: the control module 103 generates an add instruction to the server 2 when there is no webpage related to the keywords being searched by the server 2 but there is the number of webpage related to the keywords being searched by the search engine 3. The adding module 104 adds a new folder to the storage unit on the server 2 in response to the add instruction. The storage module 105 stores the number of network addresses associated with the webpage being searched by the search engine 3 to the new folder.

The method further includes the following steps: the determining module 106 determines whether or not there is new network addresses being searched by the search engine 3 which is not stored in the folder in the storage unit on the server 2 when there is the number of webpages related to the keywords being searched by the server 2 and there is the number of webpages related to the keywords being searched by the search engine 3. The storage module 105 stores the new network addresses associated with the webpages being searched by the search engine 3 in the folder which has already stored the number of the network addresses associated with the webpages being searched by the server 2 when the new network addresses associated with the webpage being searched by the search engine 3 is not stored in the storage unit 21.

Although various embodiments have been specifically described, the disclosure is not to be construed as being limited thereto. Various changes or modifications may be made to the embodiments without departing from the scope and spirit of the disclosure.

What is claimed is:

1. An information searching system comprising:
an input unit configured to receive accounting information and keywords, wherein the accounting information has an authority to access a server;
a storage unit configured to store a plurality of folders, wherein each folder stores one or more network addresses, each network address corresponds to a webpage, at least one processor; and
a plurality of modules to be executed by the at lease one processor, wherein the plurality of modules comprises:
an instruction generating module configured to generate a searching instruction, and provide the searching instruction to the server in response to the keywords input in a search engine, wherein the searching instruction is configured to control the server for searching for a plurality of webpages related to the keywords; and
a network address display module configured to display the network addresses associated with the webpages which are searched by the server.

2. The information searching system as described in claim 1, wherein the instruction generating module is further configured to provide the searching instruction to the search engine when there is no webpage being searched by the server, the search instruction is further configured to control the search engine for searching for a plurality of webpages related to the keywords, and the network address display module is further configured to display the network addresses associated with the webpages which are searched by the search engine.

3. The information searching system as described in claim 1, wherein the instruction generating module is further configured to provide the searching instruction to the server and the search engine, the searching instruction is configured to control the server and the search engine for searching for a plurality of webpages related to the keywords, and the network address display module is further configured to generate a display interface when there is the plurality of webpages being searched by the server and the search engine, the display interface comprises a first portion and a second portion, the network address display module displays the network addresses associated with the webpages being searched by the server on the first portion, and displays the network addresses associated with the webpages being searched by the search engine on the second portion.

4. The information searching system as described in claim 2, wherein the plurality of modules further comprises:
a control module configured to generate an add instruction to the server when there is no webpage related to the keywords being searched by the server but there is the plurality of webpages related to the keywords being searched by the search engine;
an adding module configured to add a new folder to the storage unit on the server in response to the add instruction; and
a storage module configured to store the plurality of network addresses associated with the webpages being searched by the search engine to the added new folder.

5. The information searching system as described in claim 3, wherein the plurality of modules further comprises:
a determining module configured to determine whether or not there is new network addresses being searched by the search engine which is not stored in the folder in the storage unit when there is the plurality of webpages related to the keywords being searched by the server and there is the plurality of webpages related to the keywords being searched by the search engine; and
a storage module configured to store the new network addresses associated with the webpages being searched by the search engine in the folder which has already stored the plurality of the network addresses associated with the webpages being searched by the server when the new network addresses associated with the webpages being searched by the search engine is not stored in the storage unit.

6. An information searching method comprising:
generating a searching instruction, and providing the searching instruction to a server in response to keywords input in a search engine, wherein the searching instruction is configured to control the server for searching for a plurality of webpages related to the keywords; and
displaying network addresses associated with the webpages which are searched by the server.

7. The information searching method as described in claim 6, the method comprising:
providing the search instruction to the search engine when there is no webpage being searched by the server, wherein the searching instruction is further configured to control the search engine for searching for a plurality of webpages related to the keywords; and
displaying the network addresses associated with the webpages which are searched by the search engine.

8. The information searching method as described in claim 6, the method comprising:
providing the searching instruction to the server and the search engine, wherein the searching instruction is configured to control the server and the search engine for searching for a plurality of webpages related to the keywords;
generating a display interface when there is the webpages being searched by the server and the search engine, wherein the display interface comprises a first portion and a second portion; and
displaying the network addresses associated with the webpages being searched by the server on the first portion, and displaying the network addresses associated with the webpages being searched by the search engine on the second portion.

9. The information searching method as described in claim 7, the method comprising:
generating an add instruction to the server when there is no webpage related to the keywords being searched by the server but there is the plurality of webpages related to the keywords being searched by the search engine;
adding a new folder to the storage unit on the server in response to the add instruction; and
storing the plurality of network addresses associated with the webpages being searched by the search engine to the added new folder.

10. The information searching method as described in claim 8, the method comprising:
determining whether or not there is new network addresses being searched by the search engine which is not stored in the folder in the storage unit on the server when there is the plurality of webpages related to the keywords being searched by the server and there is the plurality of webpages related to the keywords being searched by the search engine; and
storing the new network addresses associated with the webpages being searched by the search engine in the folder which has already stored the plurality of the network addresses associated with the webpages being searched by the server when the new network addresses associated with the webpages being searched by the search engine is not stored in the storage unit.
